(19) United States
(12) Patent Application Publication
(10) Pub. No.: US 2008/0148896 A1
(43) Pub. Date: Jun. 26, 2008

(54) Dry tuned gyroscope utilizing silicon micro-electro-mechanical hinge, gimbal and rotor

(75) Inventors: Eric Maier, Salt Lake City, UT (US); Rick Anderson, Draper, UT (US); Douglas G. Olsen, Salt Lake City, UT (US)

Correspondence Address: John H. Lynn, Suite C 103, 2915 Redhill Avenue, Costa Mesa, CA, 92626, US

(73) Assignee: Northrop Grumman Corporation

(21) Appl. No.: 11/644,481

(22) Filed: Dec. 21, 2006

(51) Int. Cl. G01C 19/04

(52) U.S. Cl. 74/5 F

(57) ABSTRACT

A gyroscope assembly comprises a shaft and a flexure device mounted on the shaft. The flexure device includes three concentric plates. A first pair of diametrically opposed hinges connected the inner plate and the central plate. A second pair of diametrically opposed hinges spaced 90° apart from the first pair of hinges connects the outer plate and the inner plate. The hinges define two perpendicular sensing axis and form a gimbal so that rotations of the outer plate about the sensing axes may be detected.

### BACKGROUND OF THE INVENTION

This invention relates generally to rotation sensors and particularly to two degree of freedom dry tuned gyroscopes that include a spinning mass, electro-optic signal pickoffs for sensing motion of the gyroscope case relative to the spinning mass and forcing coils with associated magnets to maintain the spinning mass in a fixed orientation relative to the gyroscope case to provide closed loop operation.

Prior art devices within this gyroscope class utilize a spinning mass that is supported relative to the gyroscope case by a flexure. When the gyroscope case is subjected to angular inputs, the gyroscope case moves relative to the spinning mass. A position transducer determines the change in position of the case relative to the spinning mass. The position transducer and associated electronics produce an electrical signal that is fed to a torquer coil that is mounted on the gyroscope case. A magnet assembly located in the spinning mass produces a magnetic filed that interacts with the current flowing in the torquer coil. This interaction produces a force that restores the spinning mass to a null position. The torquer current provides a measurement of the input angular rate to the gyroscope case. The flexure of the current device is formed of a metal that requires electro-discharge-machining to form the flexure in the required configuration.

The primary disadvantage of the prior art is the use of separate structures that are combined into one assembly. These separate structures interact to limit performance of the device. Furthermore, the piece parts of the assembly require tight tolerances and costly manufacturing techniques for final assembly. Also current devices require post processing to achieve the required angular spring rates.

### SUMMARY OF THE INVENTION

The present invention provides a gyroscope assembly that overcomes the foregoing described deficiencies of the prior art. A gyroscope assembly according to the present invention is an all silicon device comprising a spinning mass, hinges, gimbals and a connecting structure. The gyroscope assembly according to the present invention reduces the number of piece parts and complicated assembly techniques as compared to the prior art. Another advantage of the present invention is that rotational stops are micro-machined and fusion bonded to the gimbal. Micro-machining and silicon bonding processes allow the assemblies to be produced in a low cost batch process and provide the ability to tune the angular spring rate without using a post machining tuning process. The all-silicon structure of the present invention minimizes mechanical stresses developed over the operating temperature range, which provides improved performance. The present invention includes a metallization pattern on the rotor, which provides a simplification of the rotor angular position sensor, or pickoff.

A gyroscope assembly according to the present invention comprises a shaft and a flexure device mounted to the shaft. The flexure device has an inner flexure portion formed generally as a thin cylindrical plate having a central passage therethrough. The flexure device is mounted on the shaft so that the shaft passes through the central passage. The flexure device further includes an outer flexure portion formed as a thin cylindrical plate having a central opening having a diameter such that the inner flexure portion fits within the central opening spaced apart from the outer flexure portion. A first hinge is arranged to join a first outer edge portion of the inner flexure portion with a first inner edge portion of the outer flexure device. A second hinge is arranged to join a second outer edge portion of the inner flexure portion with a second inner edge portion of the outer flexure device. The outer flexure portion has a rotational degree of freedom about a sensing axis defined by a line through the first and second hinges.

The flexure device preferably includes a first inner flexure passage spaced radially inward from the first hinge arranged to form a first thin-walled inner flexure portion near the first hinge and a second inner flexure passage is spaced radially inward from the second hinge to form a second thin-walled inner flexure portion near the second hinge. A first outer flexure passage is spaced radially outward from the first hinge arranged to form a first thin-walled outer flexure portion near the first hinge, and a second outer flexure passage spaced radially inward from the second hinge arranged to form a second thin-walled outer flexure portion near the second hinge.

The gyroscope assembly of claim according to the present invention preferably has a rotor mounted on an outer rim portion of the outer flexure portion.

The gyroscope assembly according to the present invention may alternatively comprise a laminated rotor mounted on the outer flexure portion near the outer rim.

### BRIEF DESCRIPTION OF THE DRAWINGS

FIG. 1 is an exploded perspective view of a two degree of freedom gyroscope assembly according to the present invention;

FIG. 2 is a cut away perspective view of the assembled gyroscope assembly of FIG. 1;

FIG. 3 is a top plan view of the gyroscope assembly of FIGS. 1 and 2;

FIG. 4 is a bottom perspective view of a flexure device that may be included in the invention as shown in FIGS. 1-3 with a surface metallization formed thereon;

FIG. 5 is a cross sectional view of the invention as shown in FIGS. 1-4;

FIG. 6 is a cut away perspective view of a two degree of freedom gyroscope assembly according to the present invention having a laminated rotor;

FIG. 7 is a perspective view of the two degree of freedom gyroscope assembly of FIG. 6;

FIG. 8 is a cross sectional view of the embodiment of the invention shown in FIGS. 6 and 7;

FIG. 9 is a cut away perspective view of a one degree of freedom gyroscope assembly according to the present invention;

FIG. 10 bottom plan view of the embodiment of the invention shown in FIG. 9;

FIG. 11 is a top plan view of the invention as shown in FIG. 9; and

FIG. 12 is a cross sectional view of the embodiment of the invention shown in FIGS. 9-11.

### DETAILED DESCRIPTION OF THE INVENTION

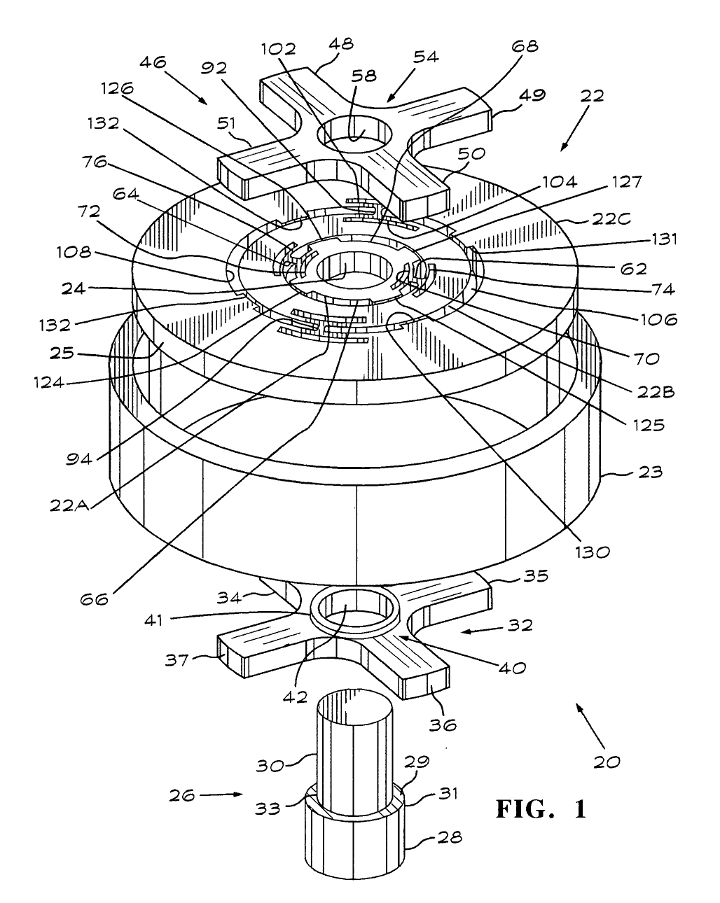

FIG. 1 is an exploded perspective view of a gyroscope assembly 20 according to the present invention. A flexure device 22 formed generally as a thin cylinder having a central passage 24 therethrough is mounted on a shaft 26. The shaft 26 is preferably formed as a stepped cylinder having a base 28. The shaft 26 includes a mounting post 30 having a diameter smaller than the base diameter extending perpendicularly from the base 28. The shaft 26 and the base 28 are axially aligned. A rotor 23 may be connected to an outer edge 25 of the flexure device.

A first stop device 32 is mounted on the mounting post 30. The stop device 32 formed generally as a thin plate having a plurality of substantially identical vanes 34-37 extending from a central region 40. A cylindrical passage 42 having a diameter that is approximately identical to the diameter of the mounting post 26 is formed in the central region 40. The vanes 34-37 preferably are spaced 90° apart around the central region 40. The central region 40 is thicker than the vanes 34-37 and has a hub 41 around the passage 42 and facing a central region 43 (shown in FIG. 2) of the flexure device 22. The vanes 34-37 thus are spaced apart by a small gap 45 from the flexure device 22.

The central passage 24 of the flexure device 22 also has a diameter that is substantially identical to the diameter of the mounting post 30. As shown in FIGS. 1, 2 and 5, the flexure device 22 is mounted on the shaft 26 such that the first stop device 32 is between the flexure device 22 and a ledge 44 formed at the juncture of the base 28 and the mounting post 30. A second stop device 46 that preferably is substantially identical to the first stop device 32 is mounted on the mounting post 30 such that the flexure device 22 is retained between the first and second stop devices 32 and 48.

A plurality of vanes 48-51 extend from a central region 54 of the second stop device 46. The second stop device 46 also includes a hub 56 around a central passage 58. The hub contacts a portion 60 of the flexure device 22 to form a small gap 57 between the vanes 48-51 and a surface 62 of the flexure device 22.

Referring to FIGS. 1-5, the flexure device 22 may be seen to comprise an inner section 22A, an intermediate section 22B and an outer section 22C. The inner section 22A is connected to the intermediate section 22B via a pair of hinges 62 and 64. Except for the hinges 62 and 64, the inner section 22A and the intermediate section 22B are separated by a pair of arcuate passages 66 and 68 formed in the flexure device 22. The hinges 62 and 64 are preferably located 180° apart and are sized such that the arcuate passages 66 and 68 are nearly semicircular. The hinges 62 and 64 may have a generally T-shaped cross sections.

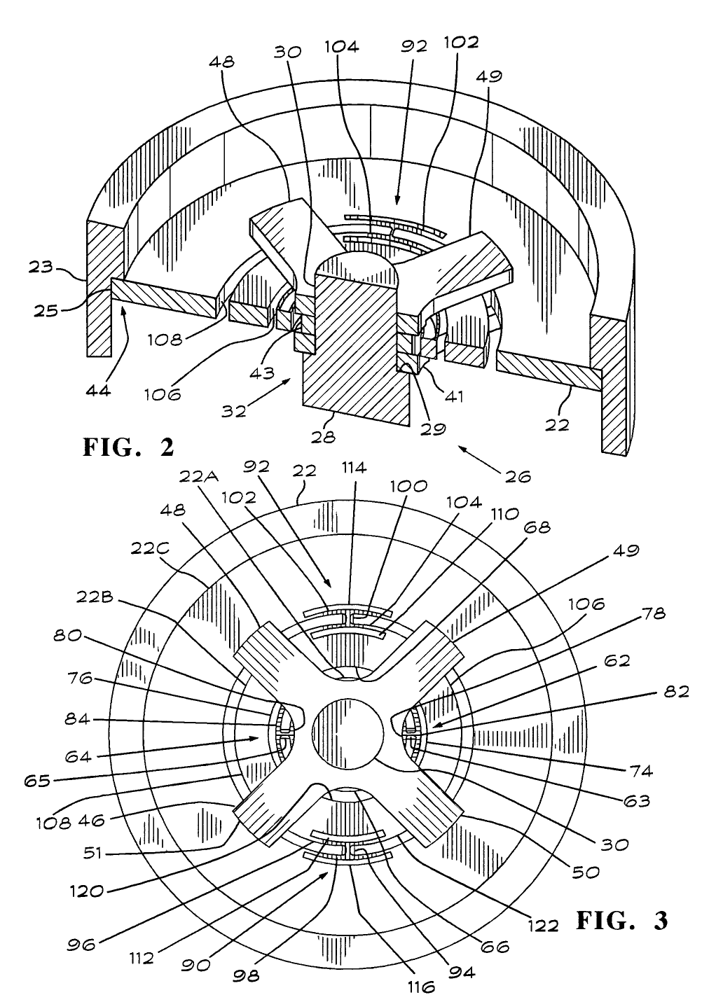

A pair of passages 70 and 72 is formed in the inner section 22A radially spaced by small distances from the inner sides of the hinges 62 and 64, respectively. Another pair of passages 74 and 76 is formed in the intermediate section 22B radially spaced by small distances from the outer sides of the hinges 62 and 64, respectively. The passages 70 and 72 cooperate with the passages 66 and 68 to form thin-walled portions 78 and 80 as shown in FIG. 3 in the inner flexure section 22A near the inner sides of the hinges 62 and 64. The passages 74 and 76 cooperate with the passages 66 and 68 to form thin-walled portions 82 and 84 in the intermediate flexure section 22B near the outer sides of the hinges 62 and 64.

Referring to FIG. 3, the hinge 62 may be formed as a thin bridge 63 connecting the inner flexure section 22A and the intermediate flexure section 22B between the thin-walled portions 78 and 80. The hinge 64 may be formed as a thin bridge 65 connecting the inner flexure section 22A and the intermediate flexure section 22B between the thin-walled portions 82 and 84.

The gyroscope assembly 20 also includes a pair of hinges 90 and 92 between the intermediate flexure section 22B and the outer flexure section 22C. The hinge 90 is formed as a bridge 94 between a first thin-walled section 96 of the intermediate flexure section 22B and a second thin-walled section 98 of the outer flexure section 22C. The hinge 92 is formed as a bridge 100 between a first thin-walled section 102 of the intermediate flexure section 22B and a second thin-walled section 104 of the outer flexure section 22C. Except for the hinges 90 and 92, the intermediate flexure section 22B and the outer flexure section 22C are separated by a pair of arcuate passages 106 and 108 in the flexure 22.

A pair of passages 110 and 112 is formed in the intermediate section 22B radially spaced by small distances from the inner sides of the hinges 92 and 94, respectively. Another pair of passages 114 and 116 is formed in the outer section 22C radially spaced by small distances from the outer sides of the hinges 92 and 94, respectively. The passages 110 and 112 cooperate with the passages 106 and 108 to form the thin-walled portions 96 and 98 in the intermediate flexure section 22B near the inner sides of the hinges 92 and 94. The passages 114 and 116 cooperate with the passages 106 and 108 to form the thin-walled portions 102 and 104 in the intermediate flexure section 22B near the outer sides of the hinges 106 and 108.

Referring to FIGS. 1-5, the intermediate flexure section 22B has an inner edge 120 that is supported by the pair of hinges 62 and 64 and an outer edge 122 that is supported by the pair of hinges 92 and 94. The hinges 62 and 64 are arranged to be diametrically opposite one another. The hinges 92 and 94 are also diametrically opposite one another and are angularly displaced by 90° from the hinges 62 and 64. The hinges 62, 64, 92 and 94 have a degree of compliance such that the intermediate flexure section 22B functions as a gimbal for displacements.

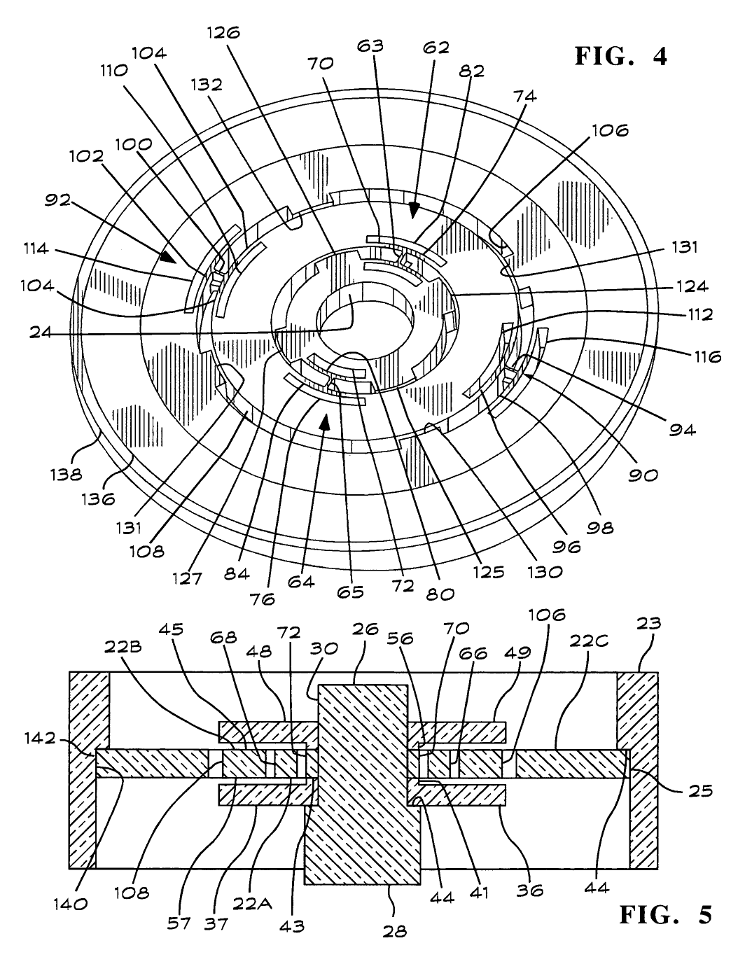

As shown in the FIG. 4, the inner flexure portion 22A includes a plurality of projections 124-127 extending radially outward therefrom. The projections 124 and 125 extend into the passage 66, and the projections 126 and 127 extend into the passage 68 toward the inner edge 120 of the central flexure section 22B. The outer flexure section 22C includes radially extending projections 130-133. The projections 130 and 131 extend radially inward into the passage 106 toward the outer edge 122 of the central flexure portion 22B. The projections 124-127 and 130-133 function as stops to limit radial displacement of the central flexure portion 22B.

Referring to FIG. 4, the gyroscope assembly 20 includes a metallization layer 136 formed on a portion 138 of the outer flexure assembly 22C. The metallization layer 136 is used to form a pickoff for signals that may be processed to determine the rotation rate detected by the gyroscope assembly 20.

The rotor 23 may be formed generally as a thin walled cylinder having an inner wall 140 that is fastened to an outer edge portion 142 of the outer flexure section 22C. Thus, the rotor 23 and the outer flexure section 22C are mounted to the gimbal formed by the central flexure section 22B. As shown in FIGS. 2 and 5, the rotor 23 may include a ledge 144 formed in the inner wall 140 to aid in forming a secure connection between the rotor 23 and the outer edge 142 of the outer flexure section 22C.

The outer flexure portion 22C has two rotational degrees of freedom defined by lines extending through the inner opposing hinge pair 62, 64 and the outer hinge pair 90, 92. Rotation about these axes is detected as being a change in a capacitance determined by the position of the pickoff metallization layer 136. In a preferred embodiment of the invention the outer flexure section 22B may have an angular displacement of about 0.5° about rotational axes defined by the two hinge pairs 62, 64 and 90, 92. Upon detection of a rotation, a feedback signal is applied to null the signal pickoff output. The feedback signal is processed to determine the rotation rate.

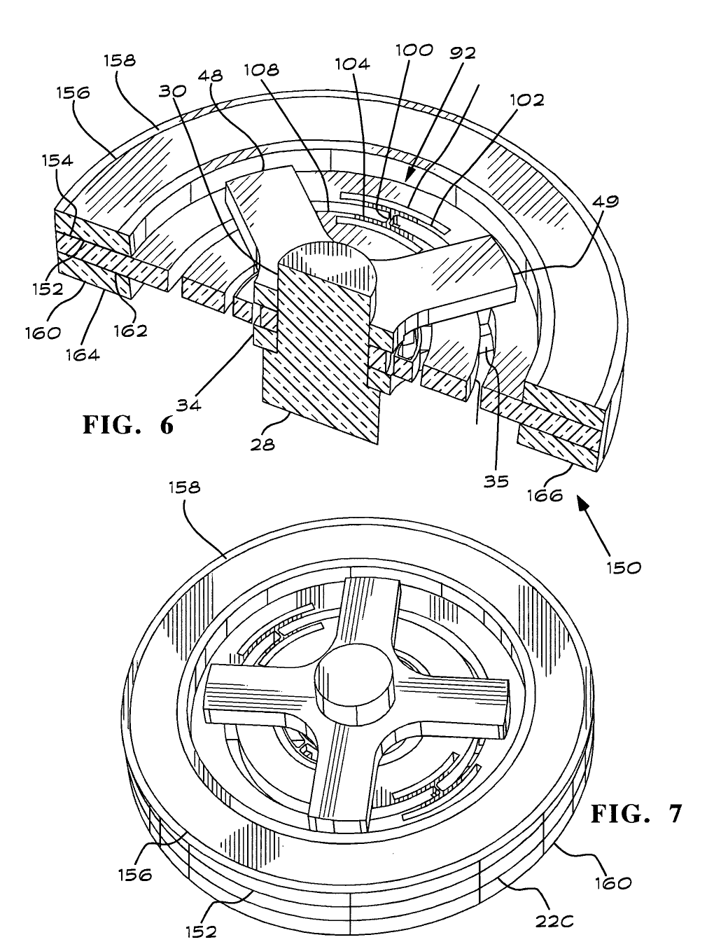

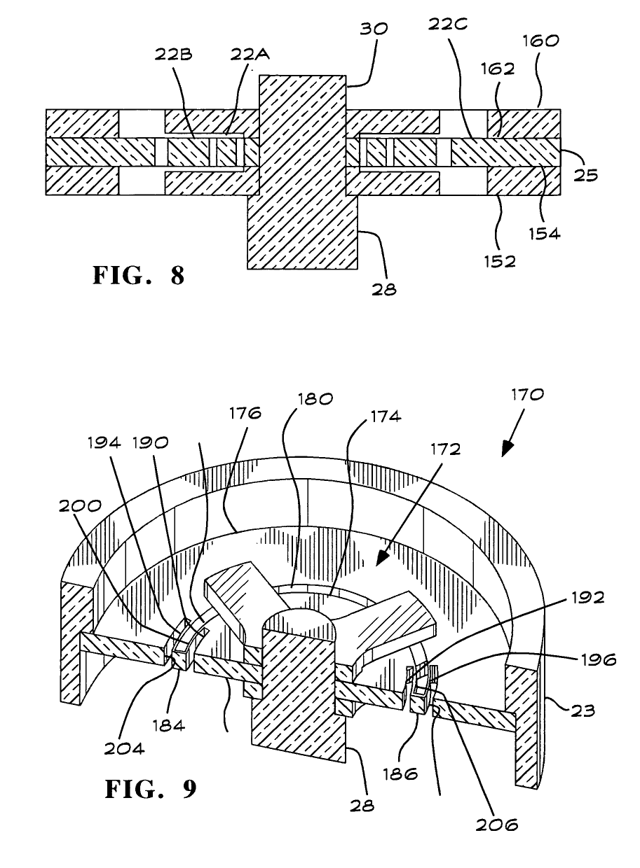

FIGS. 6-8 illustrate an alternative embodiment of the invention that includes a laminated rotor 150 that comprises a first silicon layer 152 placed on a first surface portion 154 near the outer edge 25 of the outer flexure section 22C. A first metallization layer 156 is formed on an outer surface 158 of the first silicon layer 152. The laminated rotor 150 also includes a second silicon layer 160 placed on a second surface portion 162 near the outer edge 25 of the outer flexure section 22C. A second metallization layer 164 is formed on an outer surface 166 of the first silicon layer 160.

Except for having the laminated rotor 150 instead of the one-piece rotor 23, the embodiment of the invention shown in FIGS. 6-8 is substantially identical to the embodiment shown in FIGS. 1-5.

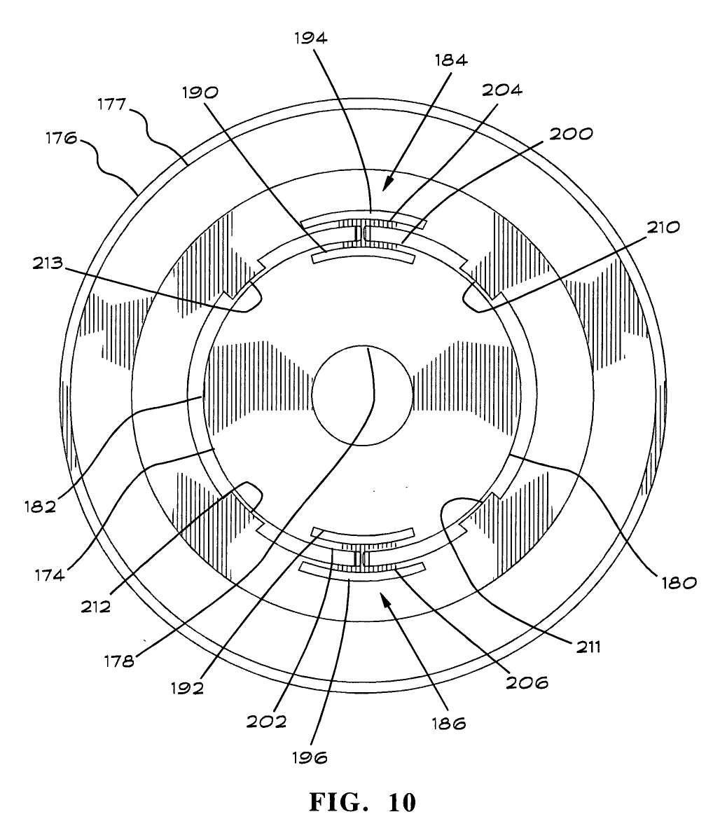

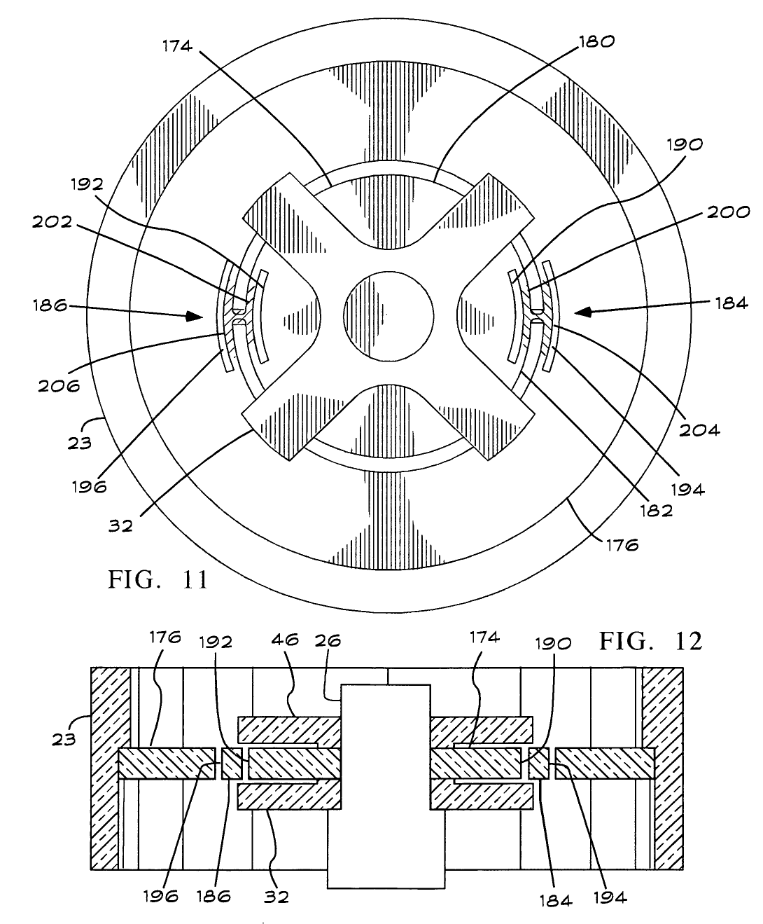

FIGS. 9-12 illustrate a one-degree of freedom gyroscope assembly 170. The gyroscope assembly 170 includes a flexure assembly 172. The flexure assembly 172 is formed to comprise an inner flexure section 174 and an outer flexure section 176. A mounting post 28 passes through a central passage 178 in the inner flexure section 174. Stop devices 32 and 46 are mounted on the mounting post 28 as described above with reference to FIGS. 1-3 and 5.

FIG. 10 is a bottom plan view of the gyroscope assembly 170 showing a pickoff metallization 177 formed on the outer flexure section 176.

Passages 180 and 182 are formed between the inner flexure section 174 and the outer flexure section 176. Hinges 184 and 186 extend between the inner flexure section 174 and the outer flexure section 176. A pair of passages 190 and 192 is formed in the inner flexure section 174 radially spaced by small distances from the inner sides of the hinges 184 and 186, respectively. Another pair of passages 194 and 196 is formed in the outer flexure section 176 radially spaced by small distances from the outer sides of the hinges 184 and 186, respectively. The passages 190 and 192 cooperate with the passages 180 and 182 to form thin-walled portions 200 and 202 in the inner flexure section 174 near the inner sides of the hinges 184 and 186. The passages 194 and 196 cooperate with the passages 180 and 182 to form thin-walled portions 204 and 206 in the outer flexure section 176 near the outer sides of the hinges 106 and 108. The hinges 184 and 186 are spaced apart by 180° so that the outer flexure portion 174 has a single rotational degree of freedom about a line extending through the hinges 184 and 186.

The gyroscope assembly 170 includes a plurality of radial displacement 210-213 stops that limit the range of radial movement of the inner flexure section 174 relative to the outer flexural section 176.

The various components of the invention are preferably fabricated using Micro-Electro-Mechanical Systems (MEMS) techniques. MEMS is the integration of mechanical elements, sensors, actuators, and electronics on a common silicon substrate through microfabrication technology. While electronics are typically fabricated using integrated circuit (IC) process sequences (e.g., CMOS, Bipolar, or BICMOS processes), micromechanical components are fabricated using compatible “micromachining” processes that selectively etch away parts of the silicon wafer or add new structural layers to form the mechanical and electromechanical devices.

What is claimed is:

1. A gyroscope assembly, comprising:
a shaft; and
a flexure device having an inner flexure portion formed generally as a thin cylinder having a central passage therethrough, the flexure device being mounted on the shaft so that the shaft passes through the central passage, the flexure device further including an outer flexure portion formed as a thin cylinder having a central opening having a diameter such that the inner flexure portion fits within the central opening spaced apart from the outer flexure portion, a first hinge arranged to join a first outer edge portion of the inner flexure portion with a first inner edge portion of the outer flexure device; a second hinge arranged to join a second outer edge portion of the inner flexure portion with a second inner edge portion of the outer flexure device, the outer flexure portion having a rotational degree of freedom about a sensing axis defined by a line through the first and second hinges; a first inner flexure passage spaced radially inward from the first hinge arranged to form a first thin-walled inner flexure portion near the first hinge; a second inner flexure passage spaced radially inward from the second hinge arranged to form a second thin-walled inner flexure portion near the second hinge; a first outer flexure passage spaced radially outward from the first hinge arranged to form a first thin-walled outer flexure portion near the first hinge; and a second outer flexure passage spaced radially inward from the second hinge arranged to form a second thin-walled outer flexure portion near the second hinge.

2. The gyroscope assembly of claim 1 wherein the shaft and the flexure device are formed of silicon and the first and second hinges are formed using micro-electro-mechanical mechanical systems techniques.

3. The gyroscope assembly of claim 1, further comprising a pair of axial stop devices mounted on the shaft on opposite sides of the inner flexure portion.

4. The gyroscope assembly of claim 1, further comprising a plurality of projections extending radially inward from the outer flexure device toward the inner flexure portion to limit radial movement of the outer flexure portion relative to the inner flexure portion.

5. The gyroscope assembly of claim 1, further comprising a metallization layer formed on a surface of the outer flexure portion to form a signal pickoff for detecting rotation about the sensing axis.

6. The gyroscope assembly of claim 1 wherein the outer flexure portion has an outer rim and wherein a rotor is mounted around the outer rim of the outer flexure portion.

7. The gyroscope assembly of claim 1, further comprising a laminated rotor, the laminated rotor including a first silicon layer formed as a thin hollow cylindrical plate mounted on the outer flexure portion near an outer edge portion on a first side thereof and a second silicon layer formed as a thin hollow cylindrical plate mounted on the outer flexure portion near an outer edge portion on a second side of the outer flexure portion.

8. The gyroscope assembly of claim 7, further comprising a metallization layer formed on a surface of the laminated rotor.

9. The gyroscope assembly of claim 1, further comprising an intermediate flexure portion between the inner and outer flexure portions, the intermediate flexure portion being connected to the inner flexure portion by a first pair of diametrically opposed hinges and being connected to the outer flexure portion by a second pair of diametrically opposed hinges, the first pair of hinges defining a first rotational axis and the second pair of hinges defining a second rotational axis that is perpendicular to the first rotational axis.

10. The gyroscope assembly of claim 9, further comprising a pair of axial stop devices mounted on the shaft on opposite sides of the inner flexure portion.

11. The gyroscope assembly of claim 9, further comprising a plurality of projections extending radially inward from the outer flexure device toward the inner flexure portion to limit radial movement of the outer flexure portion relative to the inner flexure portion.

12. The gyroscope assembly of claim 9, further comprising a metallization layer formed on a surface of the outer flexure portion to form a signal pickoff for detecting rotation about the sensing axis.

13. The gyroscope assembly of claim 9 wherein the outer flexure portion has an outer rim and wherein a rotor is mounted around the outer rim of the outer flexure portion.

14. The gyroscope assembly of claim 9, further comprising a laminated rotor, the laminated rotor including a first silicon layer formed as a thin hollow cylindrical plate mounted on the outer flexure portion near an outer edge portion on a first side thereof and a second silicon layer formed as a thin hollow cylindrical plate mounted on the outer flexure portion near an outer edge portion on a second side of the outer flexure portion.

15. The gyroscope assembly of claim 14, further comprising a metallization layer formed on a surface of the laminated rotor.

16. A gyroscope assembly, comprising:
a shaft; and
a flexure device having an inner flexure portion formed generally as a thin cylindrical plate having a central passage therethrough, the flexure device being mounted on the shaft so that the shaft passes through the central passage, the flexure device further including an outer flexure portion formed as a thin cylindrical plate having a central opening having a diameter such that the inner flexure portion fits within the central opening spaced apart from the outer flexure portion, a first hinge arranged to join a first outer edge portion of the inner flexure portion with a first inner edge portion of the outer flexure device; a second hinge arranged to join a second outer edge portion of the inner flexure portion with a second inner edge portion of the outer flexure device, the first and second hinges being aligned 180° apart such that a line through the first and second hinges defines a sensing axis, the outer flexure portion having a rotational degree of freedom about the sensing axis such that rotation of the outer flexure portion may be detected to measure the rotation.

17. The gyroscopic assembly of claim 16 wherein a first inner flexure passage is formed in the inner flexure portion spaced radially inward from the first hinge and arranged to form a first thin-walled inner flexure portion near the first hinge; a second inner flexure passage formed in the inner flexure portion and spaced radially inward from the second hinge arranged to form a second thin-walled inner flexure portion near the second hinge; a first outer flexure passage formed in the outer flexure portion and spaced radially outward from the first hinge arranged to form a first thin-walled outer flexure portion near the first hinge; and a second outer flexure passage formed in the outer flexure portion and spaced radially inward from the second hinge arranged to form a second thin-walled outer flexure portion near the second hinge.

18. The gyroscope assembly of claim 16, further comprising an intermediate flexure portion between the inner and outer flexure portions, the intermediate flexure portion being connected to the inner flexure portion by a first pair of diametrically opposed hinges and being connected to the outer flexure portion by a second pair of diametrically opposed hinges, the first pair of hinges defining a first rotational axis and the second pair of hinges defining a second rotational axis that is perpendicular to the first rotational axis.
